(19) United States
(12) Patent Application Publication
(10) Pub. No.: US 2021/0054799 A1
(43) Pub. Date: Feb. 25, 2021

(54) GAS FLOW RATE MEASUREMENT DEVICE AND GAS FLOW RATE MEASUREMENT METHOD

(71) Applicant: DENSO CORPORATION, Kariya-city (JP)

(72) Inventors: Akitoshi MIZUTANI, Kariya-city (JP); Noboru KITAHARA, Kariya-city (JP)

(21) Appl. No.: 17/091,213

(22) Filed: Nov. 6, 2020

Related U.S. Application Data
(63) Continuation of application No. PCT/JP2019/019340, filed on May 15, 2019.

(30) Foreign Application Priority Data
May 18, 2018 (JP) 2018-096137

(51) Int. Cl. F02D 41/18; G01F 15/04; G01F 1/72; G01F 1/696

(52) U.S. Cl. CPC F02D 41/18; G01F 1/6965; G01F 1/72; G01F 15/043

(57) ABSTRACT

A gas flow rate measurement device includes a flow rate sensor that outputs a voltage that includes variations due to differences in an external environment and variations due to individual differences, a correction coefficient storage unit that stores a correction coefficient for correcting the output voltage of the flow rate sensor based on a corresponding relationship between the output voltage of the flow rate sensor and the flow rate of the gas, and a correction calculation unit that corrects the output voltage of the flow rate sensor by using the correction coefficient. The correction coefficient is a coefficient for directly converting the output voltage of the flow rate sensor into an ideal voltage value that does not include the variations due to the differences in the external environment and does not include the variations due to the individual differences in the flow rate sensor.

### CROSS REFERENCE TO RELATED APPLICATIONS

The present application is a continuation application of International Patent Application No. PCT/JP2019/019340 filed on May 15, 2019, which designated the U.S. and claims the benefit of priority from Japanese Patent Application No. 2018-96137 filed on May 18, 2018. The entire disclosures of all of the above applications are incorporated herein by reference

### TECHNICAL FIELD

The present disclosure relates to a gas flow rate measurement device and a gas flow rate measurement method.

### BACKGROUND

Gas flow rate measurement devices are known to be provided in, for example, an intake passage of a vehicle to measure the flow rate of gas passing through the passage.

### SUMMARY

In one aspect of the present disclosure, a gas flow rate measurement device includes a flow rate sensor that, according to a flow rate of a gas to be measured, outputs a voltage that includes variations due to differences in an external environment and variations due to individual differences, a correction coefficient storage unit that stores a correction coefficient for correcting the output voltage of the flow rate sensor based on a corresponding relationship between the output voltage of the flow rate sensor and the flow rate of the gas, which differs depending on the differences in the external environment and the individual differences of the flow rate sensor, and a correction calculation unit that corrects the output voltage of the flow rate sensor by using the correction coefficient, wherein the correction coefficient is a coefficient for directly converting the output voltage of the flow rate sensor into an ideal voltage value that does not include the variations due to the differences in the external environment and does not include the variations due to the individual differences in the flow rate sensor.

In another aspect of the present disclosure, a gas flow rate measurement method includes a step of acquiring a voltage from a flow rate sensor that depends on a flow rate of a gas to be measured, the voltage including variations due to temperature of the gas and variations due to individual differences, a step of acquiring the temperature of the gas from a temperature sensor, a step of, using a map that defines a correction coefficient for correcting the output voltage of the flow rate sensor based on a corresponding relationship between the output voltage of the flow rate sensor and the flow rate of the gas, which differs depending on the differences in the external environment and the individual differences of the flow rate sensor, calculating the correction coefficient using the temperature of the gas and the output voltage of the flow rate sensor as arguments, a step of correcting the output voltage of the flow rate sensor based on the correction coefficient, and a step of converting the corrected output voltage into SENT communication format, wherein the correction coefficient is a coefficient for directly converting the output voltage of the flow rate sensor into an ideal voltage value that does not include the variations due to the differences in the external environment and does not include the variations due to the individual differences in the flow rate sensor.

### BRIEF DESCRIPTION OF DRAWINGS

The above and other objects, features and advantages of the present disclosure will become more apparent from the following detailed description made with reference to the accompanying drawings. In the drawings:

FIG. 1 is a block diagram of a gas flow rate measurement device according to the first embodiment.

FIG. 2 is a first explanatory view showing the concept of correction in the first embodiment.

FIG. 3 is a second explanatory view showing the concept of correction in the first embodiment.

FIG. 4 is a third explanatory view showing the concept of correction in the first embodiment.

FIG. 5 is a map defining correction coefficients for correction in the first embodiment.

FIG. 6 is a fourth explanatory view showing the concept of correction in the first embodiment.

FIG. 7 is a first explanatory diagram showing the concept of linear interpolation for calculating the correction coefficient in the first embodiment.

FIG. 8 is a second explanatory diagram showing the concept of linear interpolation for calculating the correction coefficient in the first embodiment.

FIG. 9 is a first explanatory diagram showing a concept of cubic interpolation for calculating a correction coefficient in another embodiment.

FIG. 10 is a second explanatory diagram showing a concept of cubic interpolation for calculating a correction coefficient in another embodiment.

FIG. 11 is a block diagram of a gas flow rate measurement device according to a second embodiment.

FIG. 12 is a block diagram illustrating a correction coefficient calculation according to the second embodiment.

FIG. 13 is a block diagram of a gas flow rate measurement device according to a third embodiment.

FIG. 14 is a block diagram illustrating a correction coefficient calculation according to a third embodiment.

FIG. 15 is a map defining temperature characteristic correction coefficients used in a comparative embodiment.

FIG. 16 is an explanatory diagram showing a concept of first-stage correction performed by using a temperature characteristic correction coefficient in a comparative embodiment.

FIG. 17 is a map defining individual difference correction coefficients used in a comparative embodiment.

FIG. 18 is an explanatory diagram showing a concept of a second-stage correction performed by using individual difference correction coefficients in a comparative embodiment.

### DETAILED DESCRIPTION

Hereinafter, a plurality of embodiments of the gas flow rate measurement device will be described with reference to the drawings. In the embodiments, components which are substantially similar to each other are denoted by the same reference numerals and redundant description thereof is omitted.

### First Embodiment

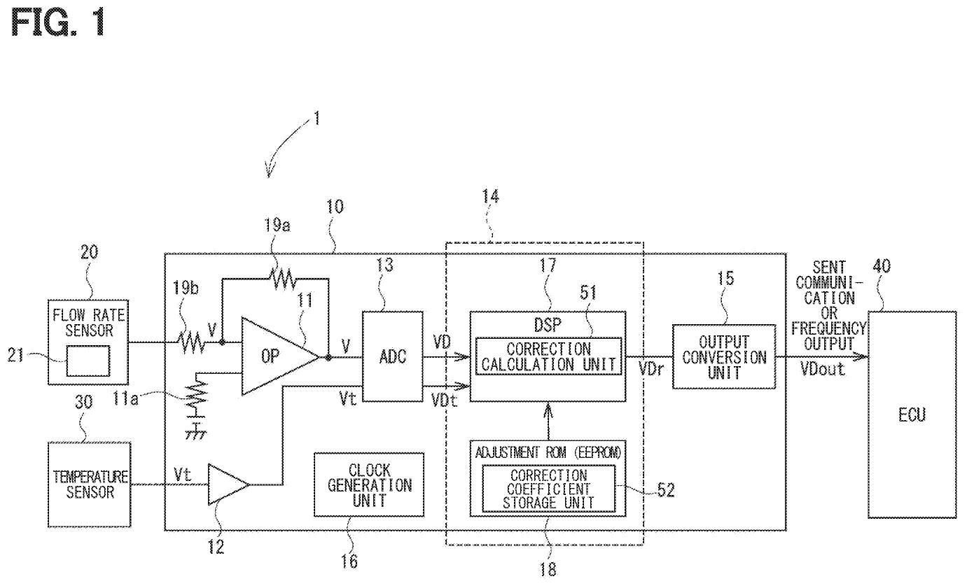

A gas flow rate measurement device according to the first embodiment is shown in FIG. 1. The gas flow rate measurement device 1 is mounted on the intake passage of a vehicle and is used for measuring the flow rate of air in the intake passage (hereinafter referred to as the intake flow rate). The gas flow rate measurement device 1 includes a flow rate sensor 20, a temperature sensor 30, a correction circuit 10, and an ECU 40.

The flow rate sensor 20 may be, for example, a heat ray type sensor, and includes a detection unit 21 made of a silicon semiconductor. The detection unit 21 includes a silicon substrate on which a thin film portion is formed, a heater resistor installed in the center of the thin film portion, and a temperature sensor used to detect flow rates on an upstream side and a downstream side of the heater resistor along the air suction direction. The temperature of the heater resistor is set so as to be higher than the intake air temperature by a set degree of temperature. As a result, an upstream-downstream symmetrical temperature distribution centered on the heater resistor is generated in the thin film portion. When air flows in, a temperature difference occurs in the temperature distribution between the upstream side and the downstream side. Since the measured flow rate is a function of this temperature difference, the temperatures upstream and downstream of the thin film portion are detected by the flow rate detection temperature sensor, and the temperature difference between the two is calculated to measure the intake flow rate. In the case of backflow, the temperature distributions on the upstream side and the downstream side are reversed, and the sign of the calculated temperature difference is also reversed, so that the directionality of the intake flow rate can be determined. Here, flow rate G is a mass flow rate (g/s). The flow rate sensor 20 outputs a voltage V corresponding to the intake flow rate.

The temperature sensor 30 is installed separately from the above-mentioned flow rate detection temperature sensor, and measures the intake air temperature. The temperature sensor 30 outputs a voltage Vt corresponding to the intake air temperature. Although not shown, the temperature sensor 30 is connected to power supply voltage via a pull-up resistor.

The correction circuit 10 includes an amplification arithmetic unit (hereinafter, operational amplifier) 11, a buffer 12, an AD converter (hereinafter, ADC) 13, a correction unit 14, an output conversion unit 15, and a clock generation unit 16. The correction unit 14 includes a digital signal processor (hereinafter, DSP) 17 as a “digital signal processing circuit” and an adjustment ROM 18 which may be, for example, an EEPROM.

The operational amplifier 11 forms an amplifier circuit. An output terminal of the flow rate sensor 20 is connected to one input terminal of the operational amplifier 11 via a resistor 19b. Further, this input terminal is connected to the output terminal of the operational amplifier 11 via a resistor 19a which is a feedback resistor. The other input terminal of the operational amplifier 11 has a constant potential via the resistor 11a. With such a configuration, the operational amplifier 11 amplifies and outputs the voltage V output by the flow rate sensor 20. The voltage V amplified by the operational amplifier 11 is input to the ADC 13.

The buffer 12 is connected to the output terminal of the temperature sensor 30 and isolates the impedance on the circuit side. The voltage Vt at the output of the buffer 12 is input to the ADC 13.

The ADC 13 converts the inputted analog value into a digital value and outputs it. Here, the voltage V corresponding to the intake flow rate is converted into a digital voltage VD and output. Further, the voltage Vt corresponding to the intake air temperature is converted into a digital voltage VDt and output. The voltage VD and the voltage VDt are input to the correction unit 14.

The correction unit 14 corrects the voltage VD to a corrected voltage VDr and outputs the corrected voltage VDr. In particular, the DSP 17 makes corrections based on a map stored in the adjustment ROM 18. The details of the correction will be described later. The corrected voltage VDr is input into the output conversion unit 15.

The output conversion unit 15 may, for example, convert the corrected voltage

VDr into a SENT communication format, and outputs it. Specifically, a pulse wave VDout in the SENT communication format corresponding to the corrected voltage VDr is output. The output conversion unit 15 is a “SENT communication conversion unit”. The pulse wave VDout is input into the ECU 40. SENT is an abbreviation for Single Edge Nibble Transmission, which is a communication protocol in which the length of time between the falling edges of two pulses represents 4 bits, and those bits are transmitted as a group of data. In alternative embodiments, the corrected voltage VDr may be converted into a format other than the SENT communication format. For example, a pulse wave having a frequency f and may be output instead.

The clock generation unit 16 generates an operation clock for operating the entire correction circuit 10 including the DSP 17. This operation clock is input into each component such that the entire correction circuit 10 operates in synchronization. However, but the input path of the operation clock is not shown in the figures in order to reduce complexity.

The ECU 40 is a “voltage to flow rate conversion unit” that converts the corrected voltage VDr into an intake flow rate. The correction by the correction unit 14 is performed before the voltage is converted into the intake flow rate by the ECU 40. In other words, the correction unit 14 corrects the output voltage at a stage prior to being converted into the flow rate.

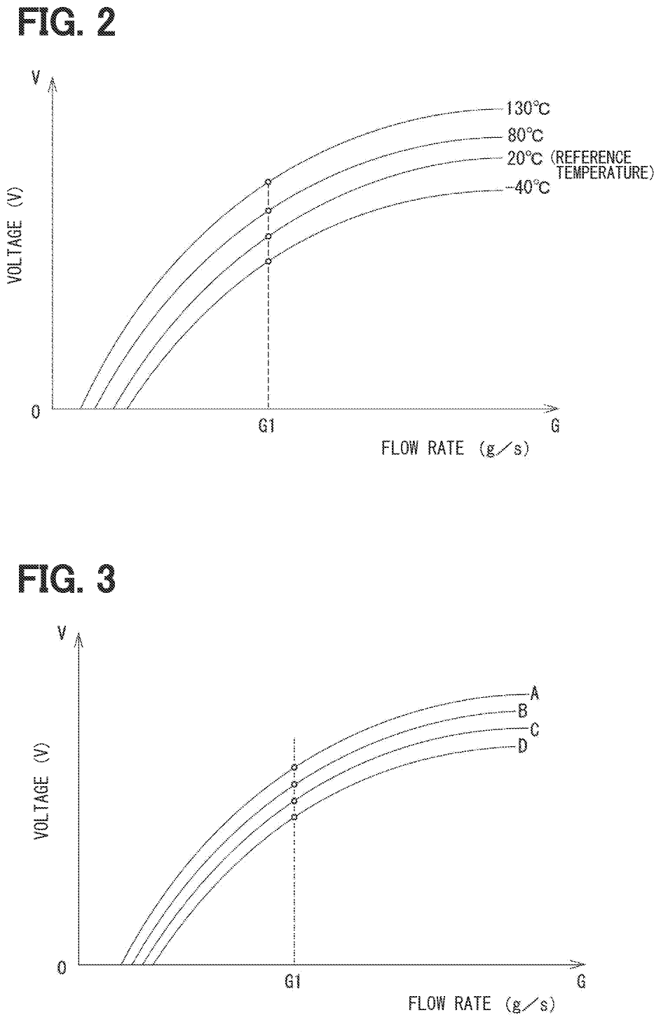

Next, the correction process in the gas flow rate measurement device 1 will be described with reference to FIG. 1 and the like. The voltage V output from the flow rate sensor 20 includes variations due to differences in the external environment such as intake air temperature and variations due to individual differences in the flow rate sensor 20. That is, even when the intake flow rate is the same, the voltage VD corresponding to the voltage V changes due to differences in external environment and due to individual differences among the flow rate sensor 20. For example, as shown in FIG. 2, even when the intake flow rate G1 is the same, the voltage VD changes when the intake temperature T is different. In this figure, examples of −40 ° C., 20 ° C., 80 ° C., and 130 ° C. are shown. Further, as shown in FIG. 3, while assuming the intake air temperature T is a predetermined reference temperature (for example, 20° C.), even if the intake flow rate G1 is the same, the voltage VD may differ depending on the individual flow rate sensor 20 being used. In this figure, four distinct flow rate sensors 20 are shown as examples: an individual A, an individual B, an individual C, and an individual D.

The correction calculation unit 51 of the DSP 17 uses the voltage VD from the ADC 13 and the voltage VDt from the temperature sensor 30 to correct the voltage VD to a voltage serving as a reference characteristic with a correction coefficient

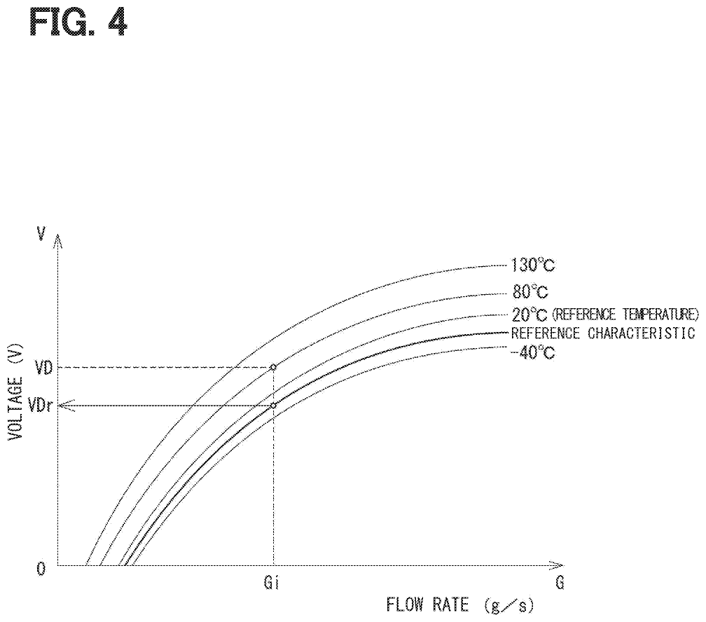

Mi. The voltage serving as the reference characteristic is an ideal voltage value (hereinafter referred to as an ideal voltage) that does not include variations due to differences in external environment and does not include variations due to individual differences in the flow rate sensor 20. Further, the correction calculation unit 51 corrects the voltage VD based on the corresponding relationship between the voltage VD and the intake flow rate G. This corresponding relationship differs depending on different intake air temperatures and individual differences in the flow rate sensor 20. As shown in FIG. 4, the corrected voltage VDr is obtained from the voltage VD and the intake air temperature. In the first embodiment, the external environment is measured as the intake air temperature.

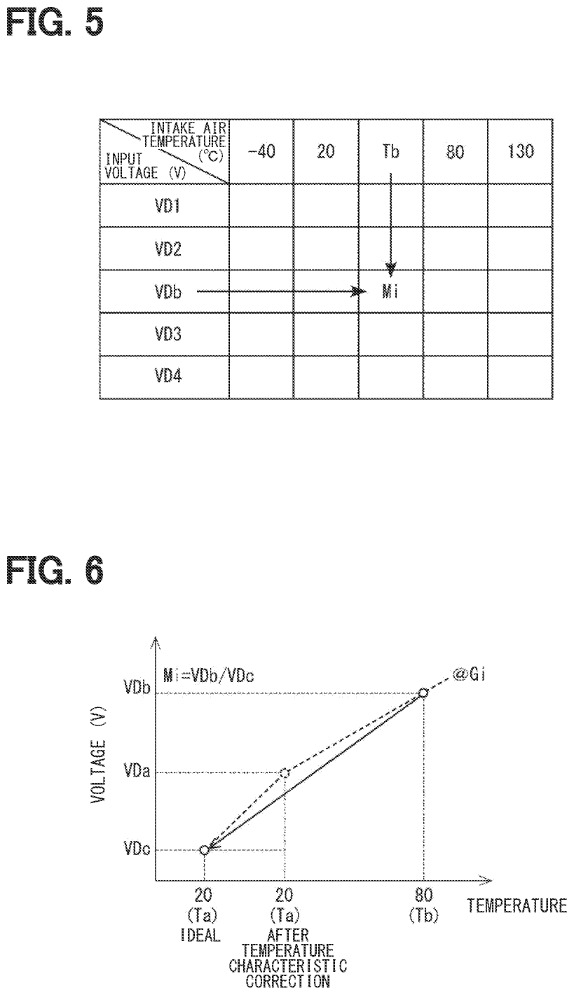

The correction coefficient storage unit 52 of the adjustment ROM 18 stores the correction coefficient Mi for correcting the voltage VD based on the corresponding relationship between the voltage VD and the intake flow rate G, which differs depending on different intake air temperatures and individual differences in the flow rate sensor 20. In the first embodiment, the correction coefficient Mi is a coefficient for directly correcting the voltage VD to the ideal voltage. Specifically, the correction coefficient storage unit 52 stores a map as shown in FIG. 5 for calculating the correction coefficient Mi with the intake air temperature T and the voltage VD as arguments.

The correction coefficient Mi defined in the map of FIG. 5 satisfies the formula [Mi=VDb/VDc]. Here, VDb is the voltage of the intake air temperature Tb at a particular flow rate value, and VDc is the ideal voltage. In other words, the correction coefficient Mi is a ratio between voltage VDb and the ideal voltage VDc. The correction calculation unit 51 obtains the correction coefficient Mi from the map shown in FIG. 5 with the intake air temperature Tb and the voltage VDb as arguments. Then, as shown in FIG. 6, the correction calculation unit 51 directly corrects the voltage VDb to the ideal voltage VDc with the equation “VDc=VDb/Mi” by using the correction coefficient Mi, and outputs the corrected voltage VDr.

More specifically, the correction coefficient Mi is calculated from the ratio Ki=VDb/VDa between the voltage VDa of the reference temperature Ta and the voltage VDb of the intake temperature Tb, and from the ratio Li=VDa/VDc between the voltage VDa of the reference temperature Ta and the ideal voltage VDc, using the formula [Mi=Ki×Li (=VDb/VDc)]. The ratio Ki corresponds to a temperature characteristic correction coefficient for correcting the voltage VDb of the intake air temperature Tb to the voltage when the intake air temperature is the reference temperature Ta. Further, the ratio Li corresponds to an individual difference correction coefficient for correcting the voltage VDa of the reference temperature Ta to the ideal voltage VDc.

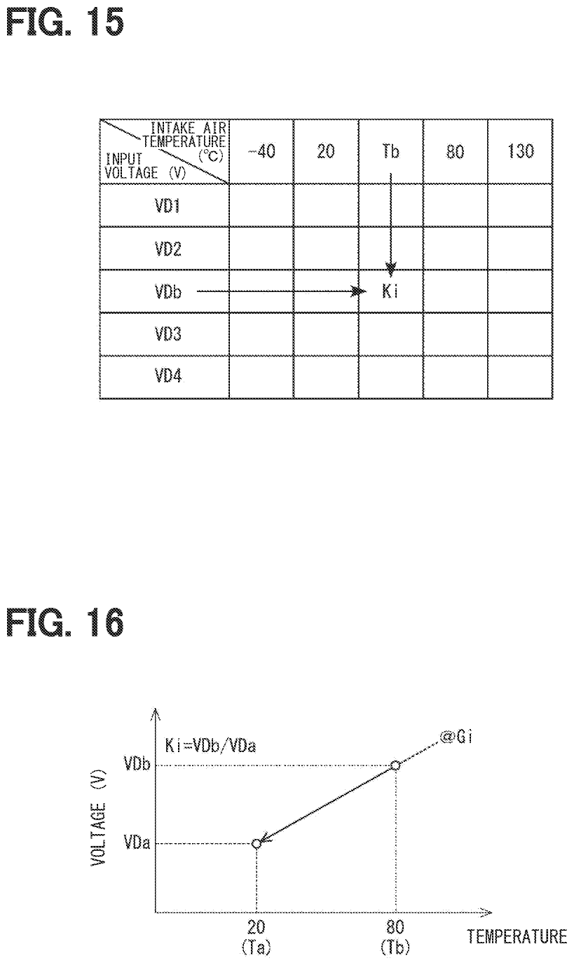

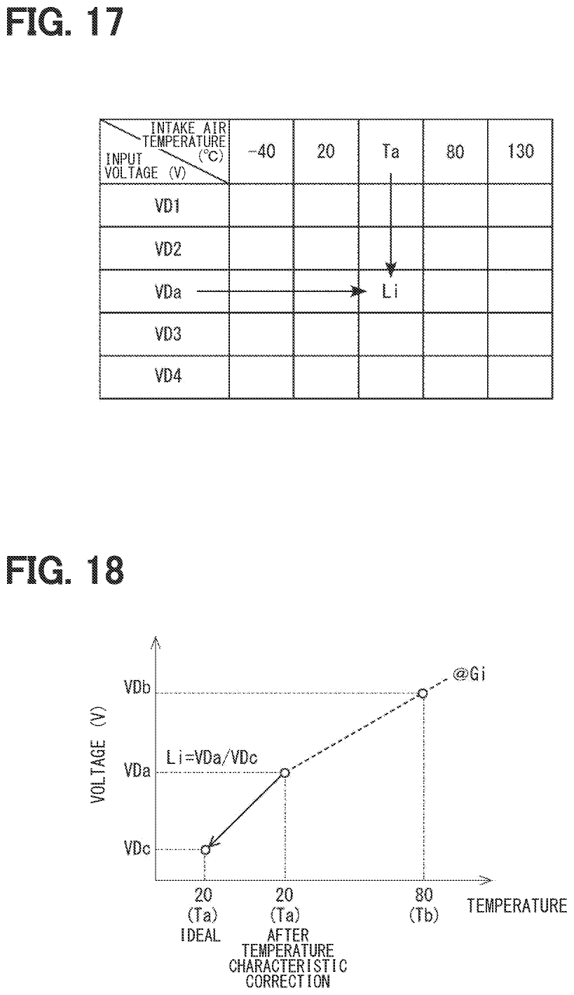

Here, in order to correct the voltage VD to the ideal voltage VDc, it is conceivable to go through the following steps (1) and (2).
(1) The temperature characteristic correction coefficient Ki is obtained from a map as shown in FIG. 15 with the intake air temperature Tb and the voltage VDb as arguments. In addition, as shown in FIG. 16, the voltage VDb is corrected to the voltage VDa by the equation [VDa=VDb/Ki] using the temperature characteristic correction coefficient Ki.
(2) The individual difference correction coefficient Li is obtained from a map as shown in FIG. 17 with the reference temperature Ta and the voltage VDa as arguments. In addition, as shown in FIG. 18, the voltage VDa is corrected to the ideal voltage VDc by the equation [VDc=VDa/Li] using the individual difference correction coefficient Li.

Hereinafter, an embodiment in which the voltage VD is corrected to the ideal voltage VDc through the procedures (1) and (2) above will be referred to as a comparative embodiment. In the comparative embodiment described above, the variations in the output voltage due to individual differences are corrected using a first map, and a second map defines the correction coefficient for correcting the output voltage to the voltage at the reference temperature. However, the above comparative embodiment method has room for improvement because it requires a relatively high storage capacity of the storage unit that stores the maps and also increases the complexity of the correction process. In contrast to this comparative embodiment, in the first embodiment, the voltage VDb is directly corrected to the ideal voltage VDc, i.e., in one step.

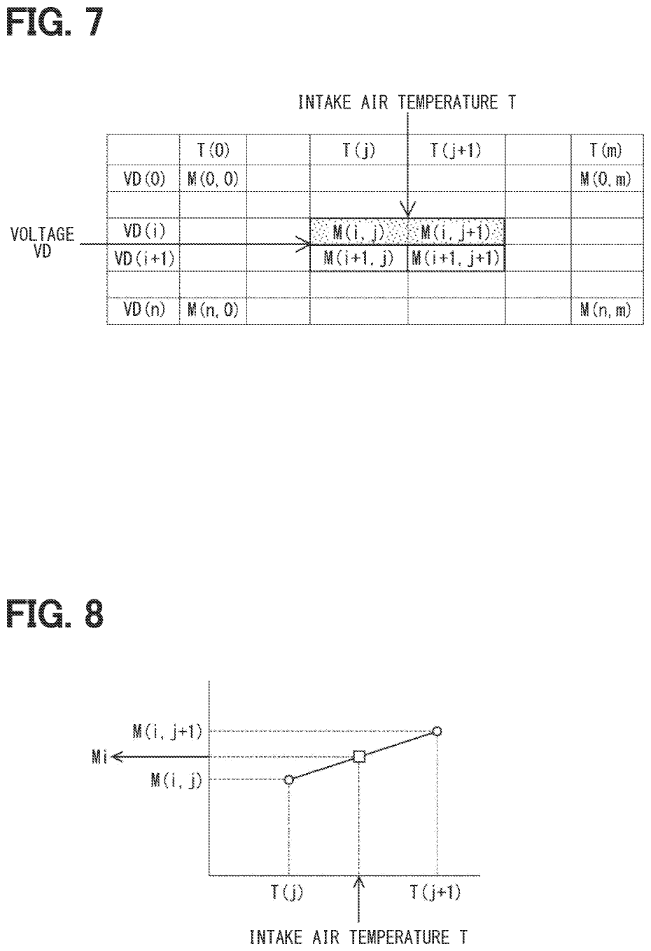

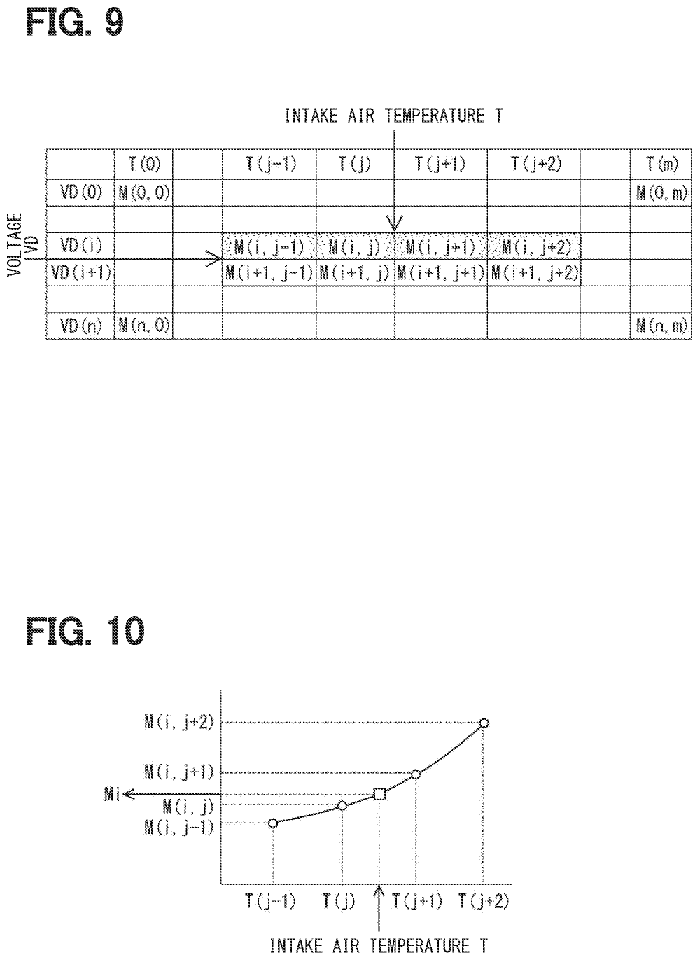

Returning to FIG. 5, in this map, the voltage VD and the intake air temperature T are both represented by a plurality of discrete values (discrete subsets). That is, the correction coefficient Mi is defined so as to correspond to a discrete subset of the intake air temperature T and a discrete subset of the voltage VD. In this example, the number of values used for the voltage VD and the intake air temperature T is about 5 to 10 in order to balance the reduction of map storage capacity (from the viewpoint of product miniaturization) while maximizing accuracy. In this case, the correction coefficient Mi is calculated by an interpolation calculation based on the map. In the first embodiment, linear interpolation is performed using two neighboring points. For example, in the intake temperature T axis of the map of FIG. 7, two points in the vicinity of the intake temperature T are obtained, a linear function as shown in FIG. 8 is derived using these two points, and this linear function is used for calculating the intermediate value. Similarly, in the voltage VD axis of FIG. 7, an intermediate value is calculated using a linear function. In this way, the correction coefficient Mi is calculated from the intake air temperature T and the voltage VD using interpolation calculation. In another embodiment, the correction coefficient Mi may be calculated by a second-order or higher interpolation calculation using two or more points. FIGS. 9 and 10 show an example of cubic interpolation using four points.

Then, the correction calculation unit 51 of the DSP 17 uses the correction coefficient Mi to calculate the pre-correction voltage VD using the following equation.

[VDr (corrected voltage, ideal voltage)=VD (pre-correction voltage)/Mi]

The pre-correction voltage VD is corrected as shown above and the corrected voltage VDr, which is the ideal voltage, is output. As described above, the corrected voltage VDr is converted into the SENT communication format or a pulse wave with frequency f by the output conversion unit 15, and output to the ECU 40.

The gas flow rate measuring method by the gas flow rate measurement device 1 described above includes the following steps (A) to (E).
(A) In accordance with the intake flow rate of a measurement target, acquiring a voltage V from the flow rate sensor 20 including variations due to intake air temperature and individual differences of the flow rate sensor 20.
(B) Acquiring the intake air temperature from the temperature sensor 30.
(C) Calculating the correction coefficient Mi with the intake air temperature and the voltage VD as arguments by using a map that defines the correction coefficient Mi for correcting the voltage VD based on the corresponding relationship between the voltage VD and the intake flow rate G, which differs depending on different intake air temperatures and individual differences in the flow rate sensor 20.
(D) Correcting the voltage VD based on the correction coefficient Mi.
(E) Converting the corrected voltage VDr into a SENT communication format or a pulse wave having a frequency f.

### Effects

In the first embodiment, the gas flow rate measurement device 1 includes the flow rate sensor 20 that outputs a voltage V according to the flow rate of the air to be measured, the correction coefficient storage unit 52 that stores the correction coefficient Mi for correcting the output voltage V of the flow rate sensor 20, and the correction calculation unit 51 that corrects the voltage VD with respect to the voltage V by using the correction coefficient Mi. The correction coefficient Mi is a coefficient for correcting the voltage VD based on the corresponding relationship between the voltage VD and the intake flow rate G. This corresponding relationship differs depending on the external environment and individual differences in the flow rate sensor 20. Further, the correction coefficient Mi is a coefficient for directly converting the voltage VD into an ideal voltage value that does not include variations due to differences in external environment and does not include variations due to individual differences in the flow rate sensor 20.

As a result, unlike the above-mentioned comparative embodiment in which the correction for variations due to differences in external environment and the correction for variations due to individual difference are performed separately, a single step correction can be performed. As a result, the storage capacity of the adjustment ROM 18 can be reduced, while also correcting the output voltage V of the flow rate sensor 20 with high accuracy. In addition, calculation speed may be improved.

Further, in the first embodiment, the external environment is the intake air temperature. Due to this, the voltage VD can be directly (i.e., in one step) corrected into an ideal voltage value that does not include variations due to differences in the intake air temperature and does not include variations due to individual differences in the flow rate sensor 20.

Further, in the first embodiment, the gas flow rate measurement device 1 includes a temperature sensor 30 for measuring the intake air temperature. The correction coefficient storage unit 52 stores a map for calculating the correction coefficient Mi with the voltage VD corresponding to the intake air temperature and the output voltage V of the flow sensor 20 as arguments. As a result, the correction coefficient can be calculated with one map that uses the intake air temperature and the voltage as axes. Therefore, it is possible to reduce the storage capacity of the adjustment ROM 18 while improving calculation speed.

Further, in the first embodiment, in the map, the correction coefficient Mi is defined so as to correspond to a discrete subset of the intake air temperature T and a discrete subset of the voltage VD. The correction calculation unit 51 performs an interpolation calculation based on the map to calculate the correction coefficient Mi. As a result, only the correction coefficients Mi of the limited map points needs to be stored in advance in the adjustment ROM 18, which is effective in reducing storage capacity.

Further, in the first embodiment, the correction coefficient Mi defined in the map satisfies the formula [Mi=VDb/VDc]. Here, VDb is the output voltage of the temperature Tb at a particular flow rate value, and VDc is the ideal voltage. In other words, the correction coefficient Mi is a ratio between output voltage VDb of the temperature Tb and the ideal voltage VDc. As a result, variations due to both intake air temperature and individual differences of the flow rate sensor 20 can be corrected in one step using one correction coefficient Mi.

Further, in the first embodiment, the correction coefficient Mi defined in the map is calculated from the ratio Ki=VDb/VDa between the output voltage VDa of the reference temperature Ta and the output voltage VDb of the temperature Tb, and from the ratio Li=VDa/VDc between the output voltage VDa of the reference temperature Ta and the ideal voltage VDc, using the formula [Mi=Ki×Li (=VDb/VDc)]. In this way, the correction coefficient Mi can be calculated by a relatively simple calculation.

Further, in the first embodiment, the output conversion unit 15 converts the corrected voltage VDr into a SENT communication format or a pulse wave having a frequency f. By outputting the corrected voltage VDr in the SENT communication format or the pulse wave VDout having the frequency f, it is possible to adapt to various sensor signal input specifications on the ECU 40 side.

Further, in the first embodiment, a digital signal processing circuit is used as the correction calculation unit 51. As a result, high-precision calculations can be performed while reducing circuit size.

Further, in the first embodiment, the gas flow rate measurement device 1 includes an ECU 40 as a voltage to flow rate conversion unit that converts the corrected voltage VDr into an intake flow rate. The intake flow rate converted by the ECU 40 can be used for engine control.

Further, in the first embodiment, the gas flow rate measuring method by the gas flow rate measurement device 1 includes the steps (A) to (E) described above. The correction coefficient Mi is a coefficient for directly converting the voltage VD into an ideal voltage value that does not include variations due to differences in external environment and does not include variations due to individual differences in the flow rate sensor 20. As a result, it is possible to correct the output voltage V of the flow rate sensor 20 with high accuracy while reducing the storage capacity of the adjustment ROM 18. In addition, calculation speed may be improved.

### Second Embodiment

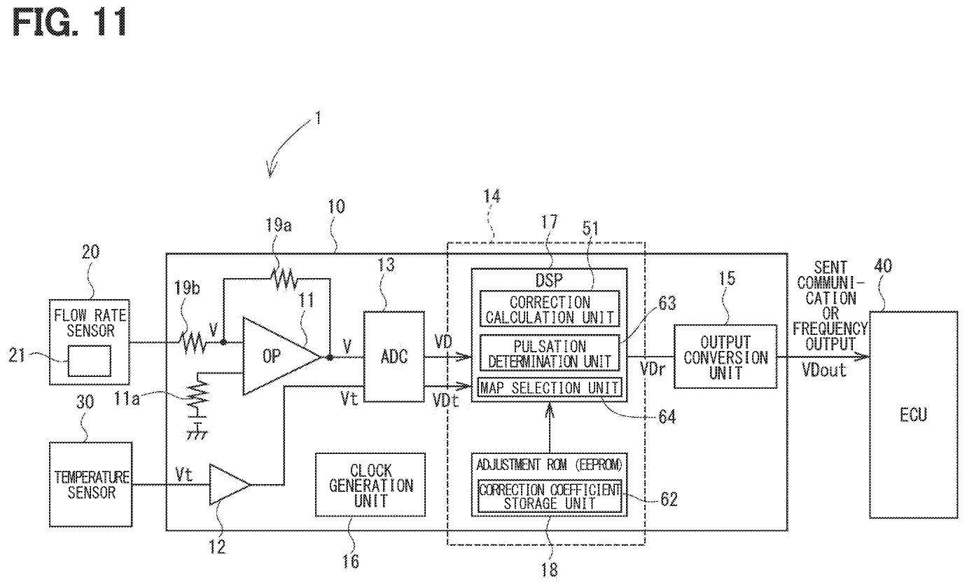

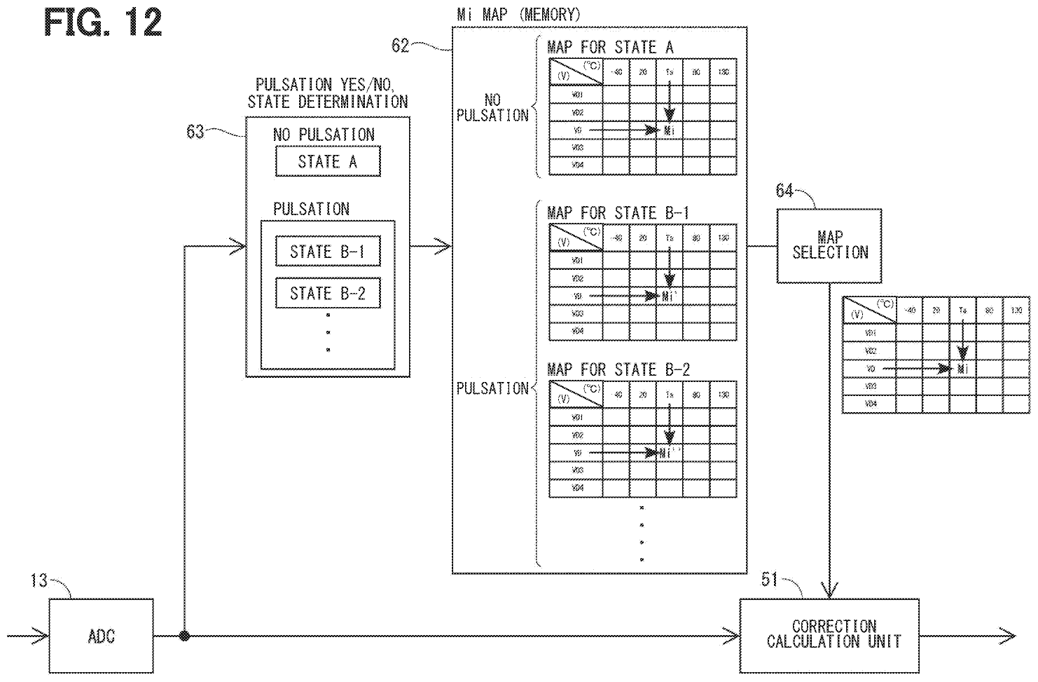

In the second embodiment, as shown in FIGS. 11 and 12, the correction coefficient storage unit 62 of the adjustment ROM 18 stores a map for calculating the correction coefficient Mi according to the presence or absence of pulsation in the intake flow rate and the pulsation state. Specifically, the correction coefficient storage unit 62 stores a state A map corresponding to a state without pulsation in the intake flow. Further, the correction coefficient storage unit 62 stores a plurality of state B maps that correspond to states with pulsation in the intake flow. The plurality of state B maps include [state B-1 map, state B-2 map, . . . ] corresponding to [pulsation state B-1, pulsation state B-2, . . . ]. The pulsating states [B-1, B-2, . . . ] may be defined by, for example, the magnitude of the pulsation. The correction coefficient Mi of these maps is determined by measuring characteristics in advance for each pulsation state.

The pulsation determination unit 63 of the DSP 17 determines the presence or absence of pulsation of the intake flow rate and the pulsation state based on the voltage VD. The map selection unit 64 of the DSP 17 selects a map according to the presence or absence of pulsation of the intake flow rate and the pulsation state. As a result, the voltage VD can be corrected by using the correction coefficient Mi according to the presence or absence of pulsation of the intake flow rate and the pulsation state, and the output voltage V of the flow rate sensor 20 can be corrected with high accuracy. Further, the second embodiment has the same configuration as the first embodiment except for the above, and has the same effects as the first embodiment.

### Third Embodiment

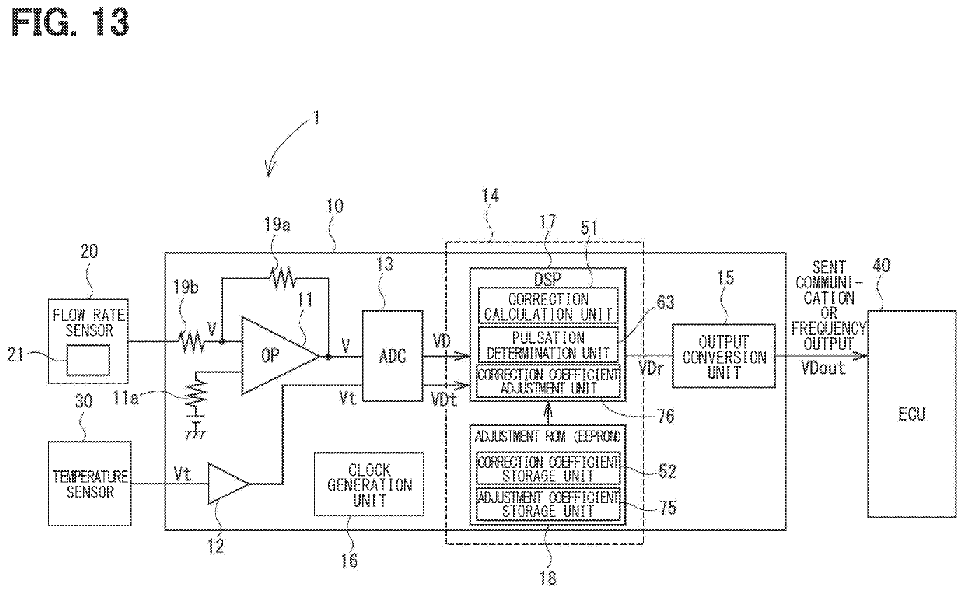

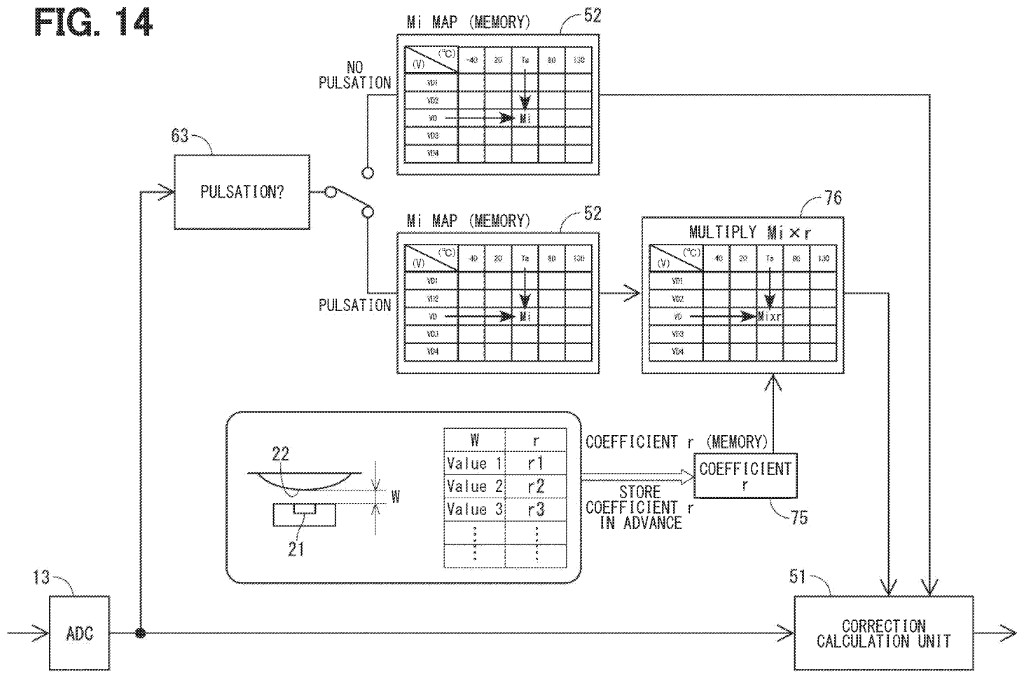

In the third embodiment, as shown in FIGS. 13 and 14, the adjustment coefficient storage unit 75 of the adjustment ROM 18 stores adjustment coefficients r for adjusting the correction coefficient Mi according to the pulsation state of the intake flow rate. The adjustment coefficients r are predetermined according to a dimensional value of the components of the flow rate sensor 20 that affect the pulsation characteristics of the intake flow rate. In the third embodiment, the dimensional value is a passage width W of a throttle portion 22 of a bypass flow path provided in the flow sensor. In another embodiment, the dimensional value may be a value other than the passage width W as long as the correction coefficient Mi varies according to the pulsating state.

The correction coefficient adjusting unit 76 of the DSP 17 adjusts the correction coefficient Mi using the adjustment coefficients r when the pulsation determination unit 63 determines that there is a pulsation of the intake flow rate. In the third embodiment, the correction coefficient Mi is multiplied by the adjustment coefficient r.

One of the factors that cause the correction coefficient Mi to differ depending on the pulsating state is variations in the passage width W described above. By measuring the passage width W and multiplying the correction coefficient r according to the passage width W by the correction coefficient Mi, the correction coefficient Mi at the time of pulsation can be adjusted by a relatively simple method. Further, in the second embodiment, the characteristics are measured in advance for each pulsation condition to determine the correction coefficients Mi of the map, but in the third embodiment, the efforts involved in the pre-measurement can be reduced. Further, the third embodiment has the same configuration as the first embodiment except for the above, and has the same effects as the first embodiment.

### Other Embodiments

In another embodiment, the voltage to flow rate conversion unit may be provided in the correction unit instead of the ECU.

The control circuit and method described in the present disclosure may be implemented by a special purpose computer which is configured with a memory and a processor programmed to execute one or more particular functions embodied in computer programs of the memory. Alternatively, the control circuit described in the present disclosure and the method thereof may be realized by a dedicated computer configured as a processor with one or more dedicated hardware logic circuits. Alternatively, the control circuit and method described in the present disclosure may be realized by one or more dedicated computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium.

The present disclosure has been described based on the embodiments. However, the present disclosure is not limited to the embodiments and structures. This disclosure also encompasses various modifications and variations within the scope of equivalents. Furthermore, various combination and formation, and other combination and formation including one, more than one or less than one element may be made in the present disclosure.

1. A gas flow rate measurement device, comprising:
a flow rate sensor that, according to a flow rate of a gas to be measured, outputs a voltage that includes variations due to differences in an external environment and variations due to individual differences;
a correction coefficient storage unit that stores a correction coefficient for correcting the output voltage of the flow rate sensor based on a corresponding relationship between the output voltage of the flow rate sensor and the flow rate of the gas, which differs depending on the differences in the external environment and the individual differences of the flow rate sensor; and
a correction calculation unit that corrects the output voltage of the flow rate sensor by using the correction coefficient,
wherein
the correction coefficient is a coefficient for directly converting the output voltage of the flow rate sensor into an ideal voltage value that does not include the variations due to the differences in the external environment and does not include the variations due to the individual differences in the flow rate sensor.

2. The gas flow rate measurement device of claim 1, wherein
the external environment is at least one of a temperature of the gas and a pulsation of the flow rate of the gas.

3. The gas flow rate measurement device of claim 2, further comprising:
a temperature sensor that measures the temperature of the gas, wherein
the correction coefficient storage unit stores a map for calculating the correction coefficient with the temperature of the gas and the output voltage of the flow rate sensor as arguments.

4. The gas flow rate measurement device of claim 3, wherein
in the map, the correction coefficient is defined so as to correspond to a discrete subset of the temperature of the gas and a discrete subset of the output voltage of the flow sensor, and
the correction calculation unit performs an interpolation calculation based on the map to calculate the correction coefficient.

5. The gas flow rate measurement device of claim 3, wherein
the correction coefficient defined in the map satisfies a formula of [Mi=VDb/VDc], in which Mi is the correction coefficient, VDb is the output voltage of a particular temperature at a particular flow rate value, and VDc is the ideal voltage, such that the correction coefficient is a ratio between output voltage of the particular temperature and the ideal voltage.

6. The gas flow rate measurement device of claim 5, wherein the correction coefficient defined in the map is calculated using a formula [Mi=Ki×Li], in which Ki is a ratio between VDb/VDa where VDa is the output voltage of a reference temperature and Li is a ratio between VDa/VDc.

7. The gas flow rate measurement device of claim 1, further comprising:
a frequency conversion unit as an output conversion unit that outputs a corrected voltage corrected by the correction calculation unit, the frequency conversion unit being configured to perform frequency conversion.

8. The gas flow rate measurement device of claim 1, further comprising:
a SENT communication conversion unit as an output conversion unit that outputs a corrected voltage corrected by the correction calculation unit, the SENT communication conversion unit being configured to perform a conversion into SENT communication format.

9. The gas flow rate measurement device of claim 1, wherein
a digital signal processing circuit is used as the correction calculation unit.

10. The gas flow rate measurement device of claim 1, further comprising:
a voltage to flow rate conversion unit that converts the corrected voltage corrected by the correction calculation unit into a flow rate.

11. The gas flow rate measurement device of claim 3, further comprising:
a correction coefficient storage unit that stores a plurality of the map according to the presence or absence of pulsation in the flow rate of the gas and according to a state of the pulsation;
a pulsation determination unit that determines the presence or absence of pulsation and the state of the pulsation in the flow rate of the gas based on the output voltage of the flow rate sensor; and
a map selection unit that selects a particular map among from the plurality of maps according to the presence or absence of pulsation of the gas flow rate and according to the state of the pulsation.

12. The gas flow rate measurement device of claim 1, further comprising:
an adjustment coefficient storage unit that stores adjustment coefficients for adjusting the correction coefficient according to a pulsation state of the flow rate of the gas, the adjustment coefficients being predetermined according to a dimensional value of components of the flow rate sensor that affect pulsation characteristics of the flow rate of the gas;
a pulsation determination unit that determines the presence or absence of pulsation and the pulsation state in the flow rate of the gas based on the output voltage of the flow rate sensor; and
a correction coefficient adjustment unit that adjusts the correction coefficient using the adjustment coefficients when it is determined that there is a pulsation in the flow rate of the gas.

13. The gas flow rate measurement device of claim 12, wherein
the dimensional value is a passage width of a throttle portion of a bypass flow path provided in the flow sensor.

14. A gas flow rate measurement method, comprising:
a step of acquiring a voltage from a flow rate sensor that depends on a flow rate of a gas to be measured, the voltage including variations due to temperature of the gas and variations due to individual differences;
a step of acquiring the temperature of the gas from a temperature sensor;
a step of, using a map that defines a correction coefficient for correcting the output voltage of the flow rate sensor based on a corresponding relationship between the output voltage of the flow rate sensor and the flow rate of the gas, which differs depending on the differences in the external environment and the individual differences of the flow rate sensor, calculating the correction coefficient using the temperature of the gas and the output voltage of the flow rate sensor as arguments;
a step of correcting the output voltage of the flow rate sensor based on the correction coefficient; and
a step of converting the corrected output voltage into SENT communication format,
wherein
the correction coefficient is a coefficient for directly converting the output voltage of the flow rate sensor into an ideal voltage value that does not include the variations due to the differences in the external environment and does not include the variations due to the individual differences in the flow rate sensor.

15. A gas flow rate measurement device, comprising:
a flow rate sensor that, according to a flow rate of a gas to be measured, outputs a voltage that includes variations due to differences in an external environment and variations due to individual differences in the flow rate sensor;
a memory having stored thereon a correction coefficient for correcting the output voltage of the flow rate sensor based on a corresponding relationship between the output voltage of the flow rate sensor and the flow rate of the gas, which differs depending on the differences in the external environment and the individual differences of the flow rate sensor; and
a processor coupled to the memory, the processor being programmed to correct the output voltage of the flow rate sensor by using the correction coefficient,
wherein
the correction coefficient is a coefficient for directly converting the output voltage of the flow rate sensor into an ideal voltage value that does not include the variations due to the differences in the external environment and does not include the variations due to the individual differences in the flow rate sensor.
